(19) United States
(12) Patent Application Publication
(10) Pub. No.: US 2026/0028062 A1
(43) Pub. Date: Jan. 29, 2026

(54) Method and Apparatus for Adjusting Suspension Stiffness and Distributing Battery Weight in an Electric Vehicle to Mimic Internal Combustion Engine Vehicle Engine Placement

(71) Applicant: Vincent Loccisano, Wellesley, MA (US)

(72) Inventor: Vincent Loccisano, Wellesley, MA (US)

(21) Appl. No.: 18/783,618

(22) Filed: Jul. 25, 2024

(51) Int. Cl. B62D 21/09; B60K 1/04; B60W 30/02; B62D 21/11

(52) U.S. Cl. CPC B62D 21/09; B60K 1/04; B60W 30/02; B62D 21/11; B60K 2001/0438

(57) ABSTRACT

A method and apparatus enables modifying the electronic controls of an EV to mimic the sensory experience of driving a specific ICE performance vehicle. Modern EVs have greatly engineered vehicle dynamics, including highly customizable and tunable shock absorbers, roll bars, and dampers that have adjustable settings for caster, camber, and ride height. Further adjusting the location of the battery platform enables an experience mimicking the feel of specific ICE performance vehicles.

### TECHNICAL FIELD

This apparatus and method relates to circuits, actuators or devices for controlling the weight distribution of batteries in an electric vehicle to mimic the weight distribution of specific internal-combustion-engine vehicles for improved driver experience.

### BACKGROUND OF THE INVENTION

While electric vehicles (EVs) and hybrid vehicles offer environmental benefits by reducing greenhouse-gas emissions and air pollution, some drivers find the driving experience to be unsatisfactory because there is little sensory feedback of the kind they are used to in traditional internal-combustion-engine (ICE) vehicles. Some consumers express a preference for the sound and vibration associated with traditional internal-combustion-engine (ICE) vehicles, whether out of nostalgia, a perception of a more engaging driving experience, or lack of feedback about vehicle performance in EVs.

Automobile electronics, including computers, electrical cables, and software protocols, are together known as a controller-area network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control unit (ECU). Current EVs may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Modern EV vehicles have software components allowing the suspension, driveline performance, and driver experience to be customizable. For example, a modern EV may have an “eco” mode that offers greater distance range; a comfort mode that tunes the suspension to be compliant and smooth; and a high-performance mode that offers the best traction, acceleration and cornering performance.

Modern electric drivetrains offer high horsepower and near-instantaneous torque, depending on the size of the car's batteries and number of electric motors. Some EVs have four electric motors, one at each wheel, enabling advanced dynamic control such as torque and power vectoring. Because of this, previously impossible levels of performance, acceleration and speed, as well as control over individual systems, are now available.

The multiple motors of an EV's subsystems enable fine-tuning of vehicle dynamics and performance under braking, acceleration and cornering. Some EVs offer four-wheel steering, with both the front and rear wheels selectively steering in sometimes-different directions. Other controls, including steering ratio, brake-pedal response, accelerator response, horsepower and torque curves are readily changed in a modern EV, simply because they require no more than electronic inputs into the drivetrain and new algorithms downloaded to the vehicle CAN. Shock absorbers and dampers that are electronically controlled can be easily reconfigurable settings. Current computing technology allows implementing variable steering ratios and vehicle performance such as understeer and oversteer.

Multiple electric motors, coupled with brakes with gyroscopic sensors, as well as a variety of other additional existing inputs, allow a vehicle chassis to be actively tuned or reprogrammed. This is possible in existing EVs and will be even more possible as these features are increasingly integrated into the development of future EVs.

Additionally, these modern and near-future electric vehicles have greatly engineered vehicle dynamics, including highly customizable and tunable shock absorbers, roll bars, and dampers. Advanced vehicles also enable remotely adjustable settings for caster, camber, and ride height.

The placement of an ICE performance vehicle's engine affects the vehicle's feel and handling. Engine placement in an ICE vehicle depends on interior space, traction, steering dynamics, acceleration, braking performance and other aspects. In a front-engine car, the most common in commuter passenger ICE vehicles, the engine is over the front axle. With this there is little chance of understeer, but a risk of oversteer, which, by comparison, is easily corrected. This architecture offers ample interior space for passengers. Front-wheel-drive, front-engine vehicles do not require complex mechanical drive trains. The configuration is cost-effective and offers ease of access for service and maintenance. Front-engine cars come with drawbacks of a high center of gravity, which leads to body roll and inferior high-speed handling.

In mid-engine ICE vehicles, the engine is behind the driver's seat. The BMW i8, Ferrari 488 GTB, Lamborghini Aventador and Porsche 718 Boxter Cayman have mid-engine placement. Generally, centered weight distribution provides superior handling and a low center of gravity that results in excellent high-speed handling and braking performance. Drawbacks to mid-engine ICE vehicles include a lack of room for rear passenger seats and a complex, expensive design for service and maintenance. A lack of mass in front of the driver poses safety concerns. Unlike with front-engine cars, airflow for removing heat from the engine is complex.

A rear-engine vehicle has rear-wheel drive and its engine mounted above the rear axle. A Porsche 911 is a well-known ICE rear-engine performance vehicle. Rear-engine vehicles offer excellent handling from superior rear-wheel traction, which provides favorable initial acceleration, but they are prone to oversteer as the front wheels are not powered, and do not have sufficient weight on them. Maintenance and repairs are more expensive than front-engine vehicles and the cooling system is complex.

EVs will soon enable finely tunable driver electronic inputs. Accelerator and brakes will no longer be physically connected to the corresponding systems of the vehicle; instead they will be electronic inputs controlled by a computer and ultimately delivered to the wheels. Modern EVs also require no physical gear-changing because these vehicles don't need a clutch or a manual transmission. Additionally, steering will be electronically rather than mechanically directed. For example, the Tesla Cyber Truck is the first mass-produced EV in which the steering wheel is a steer-by-wire system that is not rigidly connected to the turning wheels of the vehicle.

### SUMMARY OF THE INVENTION

A method and apparatus enables modifying the electronic controls of an EV to mimic the sensory experience of driving a specific ICE performance vehicle. Modern EVs have greatly engineered vehicle dynamics, including highly customizable and tunable shock absorbers, roll bars, ball joints, spherical bearings, rubber bushings, tie rods, dampers, and the like, that have adjustable settings for caster, camber, toe and alignment, and ride height.

Adjustable steering aspects include steering ratio, weight and lock to lock. Steering ratio refers to the amount, in degrees, that the steering wheel is turned and the amount, in degrees, that the wheels actually turn. Steering weight, or steering assist, refers to the amount of assistance power steering assists in the movement of the steering wheel. Lock to lock refers to the limit of a steering wheel when turned in one direction and the limit in the opposite direction. Steering aspects are electronically controlled in electric vehicles and may be altered electronically as well.

Further adjusting the location of the battery platform enables an experience mimicking the feel of specific ICE performance vehicles having rear-engine, mid-engine and front-engine designs.

A referenced internal-combustion-vehicle dynamic definition is derived from specific ICE vehicle parameters that are recorded, measured and mapped. This dynamic definition may be used to control suspension components, and battery location, to electronically alter the dynamic functions of an electric vehicle to mimic ICE performance vehicle characteristics. A baseline EV vehicle dynamics definition is also a measurement, recording and mapping of EV parameters so that they may be adjusted accordingly to mimic those of an ICE vehicle.

An apparatus includes a battery-mounting platform that may be moved by linear actuators. The platform is configured to shift the location of a battery platform so that the weight distribution of the vehicle may be centrally located in the vehicle or may be shifted fore or aft of center. Shifting the battery platform results in a driving experience of a front-engine, mid-engine or rear-engine performance ICE vehicle.

In one example embodiment, electronic driver inputs enable the adjustment of shock absorbers, and suspension components. Suspension components include roll bars, drop links, dampers, ball joints, spherical bearings, rubber bushings, tie rods and the like. In some embodiments, software-controlled suspension is achieved using rheological couplings wherein electric impulses change the stiffness of suspension components. Droop refers to the relative softness of a spring or the distance of play between the top and bottom of the spring stroke. Compression refers to the stiffness of a spring between the top and bottom of the spring stroke. Electronically controlled suspension components may also affect drivetrain performance. These electronically controlled components may also dynamically change vehicle caster, camber, toe and alignment to drastically change the vehicle performance dynamics. A rheological coupling refers to any movable component having rheological fluid governing the movement of the coupling. The stiffness of movement may be electronically adjusted by altering the charge to the rheological fluid. An eco-mode optimizes range; a comfort mode gives a smooth, compliant suspension; and a high-performance mode enables the necessary traction, acceleration and cornering performance. In an example embodiment, shifting the battery platform rearward can replicate the feel of a rear-engine ICE performance vehicle such as the Porsche 911, simulating its traction, suspension stiffness, rear-wheel drive and other aspects. In some embodiments, the effect of understeer may be imitated with sounds and/or signals that communicate that a rear-engine performance vehicle would likely experience understeer in a given situation without actually putting the driver at risk.

In the instant method and apparatus, one may replicate, for example, the vehicle dynamics, performance horsepower, torque curves, suspension settings, oversteer and understeer behavior, steering-wheel inputs and other aspects. These simulations replicate front-engine, mid-engine and rear-engine ICE vehicles to mimic the entire experience of driving an ICE performance car of choice.

### BRIEF DESCRIPTION OF DRAWINGS

FIG. 1 is a perspective view of an electric vehicle chassis.

FIG. 2 is a detail view of an electric vehicle chassis showing a front suspension assembly.

### DETAILED DESCRIPTION

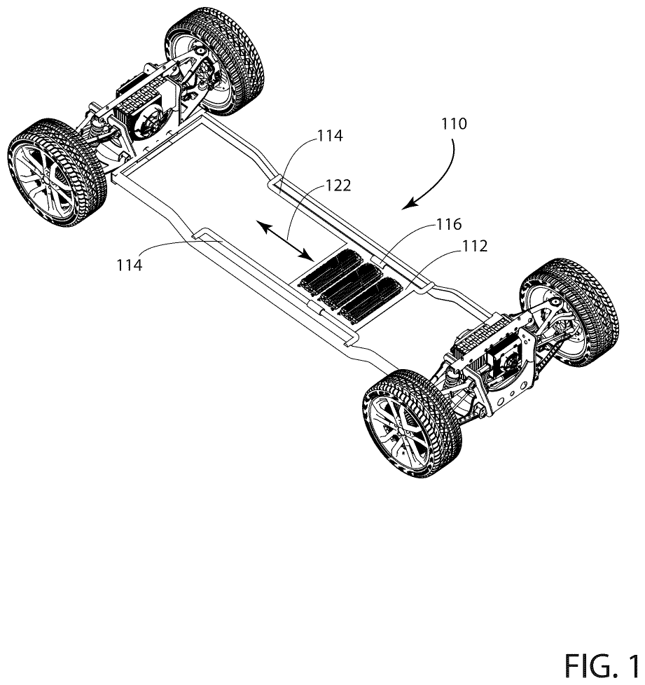

Referring to FIG. 1, an electric vehicle chassis 110 is outfitted with a movable battery bank 112. The battery bank 112 has linear actuators 116 that are coaxial with a track 114 and are configured to move forward and rearward in the vehicle as represented by arrows 122. Linear actuators are controlled by a program that is configured to mimic specific ICE performance vehicles. The configuration shown, with the battery bank shifted to the forward most position, is intended to mimic a forward-engine vehicle. Moving the battery bank 112 to the center of the vehicle mimics the feel of a mid-engine vehicle such as a Ferrari 488 GTB. In a similar example, the feel of a rear-engine vehicle like the Porsche 911 may be mimicked by moving the battery bank to the rear-most location.

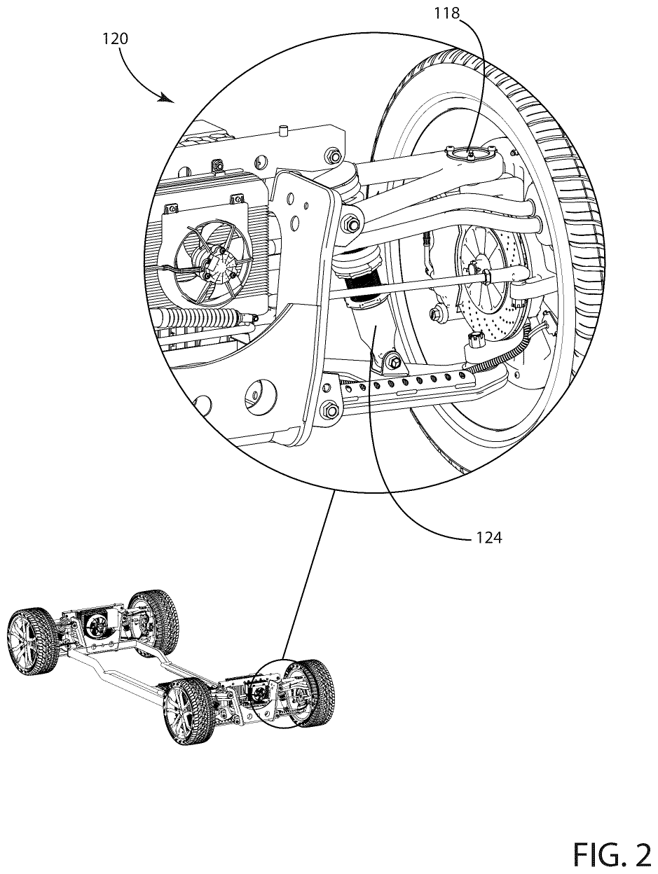

FIG. 2 is a detail view of the suspension assembly 120 of an example electric vehicle. Various components, such as a shock absorber 124 and ball joint 118 may be outfitted with electrical components to be instantly adjustable to mimic stiffness and road feel of general or specific ICE performance vehicles. One skilled in the art is familiar with rheological fluid motion actuators that can instantaneously adjust between stiff and flexible movement. The stiff suspension of a BMW i8 ICE performance vehicle, for example, may be replicated by stiffening a shock 124 and ball joint 118 for example.

A driver who wishes to experience the feel of driving a rear-engine vehicle may choose, for example, the settings associated with a Porsche 911, including the feel of the suspension to give an immersive driving experience.

1. An electric vehicle chassis comprising:
a battery compartment movably engaged with a track; and
said track fixedly engaged with a frame of said electric vehicle; wherein
said battery compartment may be moved from front, to mid, to rear of the electric vehicle to mimic the effect of a front-engine, mid-engine, and rear-engine vehicle performance.

2. The electric vehicle chassis of claim 1 further comprising:
linear-motion actuators fixedly engaged with said battery compartment and movably engaged with said track, and electrically coupled with an electronic control unit within said electric vehicle; wherein
movement of said battery compartment is controlled by software uploaded to said electronic control unit.

3. The electric vehicle chassis of claim 1 further comprising:
electronically adjustable roll bars in the suspension assembly of the electric vehicle; wherein
said roll bars may be adjusted to stiffen or loosen movement of each roll bar to mimic the road feel of an ICE performance vehicle.

4. The electric vehicle chassis of claim 1 further comprising:
electronically adjustable suspension components in the suspension assembly of the electric vehicle; wherein
said ball joints may be adjusted to stiffen or loosen movement of each ball joint to mimic the road feel of an ICE performance vehicle.

5. An electric vehicle chassis comprising:
electronically adjustable shock absorbers in the suspension assembly of the electric vehicle; wherein
said shock absorbers may be adjusted to stiffen or loosen movement of each shock absorber to mimic the road feel of an ICE performance vehicle.

6. The electric vehicle chassis of claim 5 wherein:
said shock absorbers are each a rheological coupling.

7. The electric vehicle chassis of claim 5 wherein:
suspension components in the suspension assembly of the electric vehicle are electronically adjustable; wherein
electronically adjustable suspension components dynamically change vehicle caster, camber, toe and alignment to alter the vehicle performance dynamics.

8. The electric vehicle chassis of claim 7 wherein:
suspension components are rheological couplings.

9. A method for modifying vehicle dynamics of an electric vehicle configured to mimic an internal-combustion-engine vehicle, the method comprising:
providing a referenced internal-combustion-vehicle dynamic definition; and
providing a baseline electric-vehicle dynamics definition; and
modifying the electric-vehicle baseline vehicle-dynamics definition to match an internal-combustion-engine-vehicle dynamics definition.

10. The method of claim 9 further comprising:
providing a battery pack movably engaged with a track; and
providing said track fixedly engaged with a frame of said electric vehicle; and
changing the center of gravity of the electric vehicle by moving the battery pack along the track.

11. The method of claim 9 further comprising:
modifying the electric-vehicle baseline vehicle-dynamics definition by electronically controlling suspension components to match the vehicle alignment of an internal-combustion-engine vehicle alignment.

12. The method of claim 9 further comprising:
modifying the electric-vehicle baseline vehicle-dynamics definition by electronically controlling suspension components to match the vehicle droop and compression of an internal-combustion-engine vehicle alignment.

13. The method of claim 12 further comprising:
electronically controlling suspension components to match droop and compression of an internal-combustion-engine vehicle; and
adjusting actively to road conditions.

14. The method of claim 12 further comprising;
electronically controlling suspension components to match droop and compression of an internal-combustion-engine vehicle; and
adjusting statically to the referenced internal-combustion-vehicle dynamic definition.

15. The method of claim 9 further comprising:
electronically controlling a motor in said electric vehicle to match engine-torque curve parameters of an internal-combustion-engine vehicle.

16. The method of claim 15 further comprising:
utilizing torque vectoring and individual wheel-braking and acceleration to mimic internal-combustion-engine-vehicle dynamics.

17. The method of claim 9 further comprising:
electronically controlling a motor in said electric vehicle to match engine-horsepower curve parameters of an internal-combustion-engine vehicle.

18. The method of claim 9 further comprising:
adjusting electric vehicle steering ratio to match steering ratio parameters of an internal-combustion-engine vehicle.

19. The method of claim 9 further comprising:
adjusting electric-vehicle-steering weight to match steering-weight parameters of an internal-combustion-engine vehicle.

20. The method of claim 9 further comprising:
adjusting electric vehicle steering assist parameters to match steering assist parameters of an internal-combustion-engine vehicle.

21. The method of claim 9 further comprising:
adjusting electric-vehicle steering-lock to lock parameters to match steering-lock to lock parameters of an internal-combustion-engine vehicle.
